(19) United States
(12) Patent Application Publication
(10) Pub. No.: US 2009/0226619 A1
(43) Pub. Date: Sep. 10, 2009

(54) Texturing of molding dies

(75) Inventors: Matthew Roy Summitt, Vonore, TN (US); Fred Steven Graham, Knoxville, TN (US)

Correspondence Address: HARNESS, DICKEY & PIERCE, P.L.C., P.O. BOX 828, BLOOMFIELD HILLS, MI, 48303, US

(73) Assignees: Denso International America, Inc., Southfield, MI (US); DENSO Manufacturing Tennessee, Inc., Instrument Cluster Division, Maryville, TN (US)

(21) Appl. No.: 12/075,137

(22) Filed: Mar. 7, 2008

(51) Int. Cl. B05D 3/12

(52) U.S. Cl. 427/322; 427/299

(57) ABSTRACT

A method of adhering paint to a molded component may entail providing a molding die adapted to mold the molded component, forming the molded component in the molding die, forming a texture including a plurality of recesses onto the molded component, and applying a paint to the molded component and into the plurality of recesses.

### FIELD

The present disclosure relates to molding dies and more particularly to texturing molding dies to improve the paintability of molded components.

### BACKGROUND

The statements in this section merely provide background information related to the present disclosure and may not constitute prior art.

Some paints, such as water based paints, do not adhere particularly well to certain untreated polymeric surfaces, especially molded polypropylene. For instance, polypropylene is generally known in the art to be very difficult to successfully paint with water based paint. The paint often peels and/or separates from polypropylene substrates.

The low surface tension of many molded components (especially polypropylene) may cause liquids, such as paint, to bead up on the surface of the component rather than wetting the material and adhering thereto. Low surface tension in the material results in a high contact angle between the surface of the material and the liquid paint.

Liquid droplets may exhibit contact angles greater than 90 degrees on hydrophobic surfaces. This high contact angle causes the liquid paint to form compact droplets on the molded component. Intermolecular forces within the liquid paint droplets may act to maintain the droplet form, resisting the paint's ability to spread and wet the material, thereby hindering adhesion.

Thus, it can be difficult to achieve adequate adhesion of paint (e.g., water based paint) to molded components, especially polypropylene and other polymeric components, while maintaining streamlined and efficient manufacturing processes, consistent with lean manufacturing principles.

### SUMMARY

A method of adhering paint to a molded component may entail providing a molding die adapted to mold the molded component, forming the molded component in the molding die, forming a texture including a plurality of recesses onto the molded component, and applying a paint to the molded component and into the plurality of recesses.

In another embodiment, a method of adhering paint to a polypropylene component may entail forming a molding die adapted to shape a polypropylene component, sandblasting a texture into a surface of the molding die, the texture including a plurality of recesses, molding the polypropylene component in the molding die, the texture imprinting onto a surface of the polypropylene component, and applying a paint to the surface of the polypropylene component. The texture increases a surface tension of the polypropylene component to facilitate adhesion of the paint to the surface of the polypropylene component.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flowchart illustrating an embodiment of a method of adhering paint to a component according to the principles of the present disclosure;

FIG. 2 is a perspective view of a component and a molding die having a texture according to the principles of the present disclosure;

FIG. 3 is a detail view of a partially painted surface of the component of FIG. 2 having a texture imprinted thereon according to the principles of the present disclosure; and

FIG. 4 is a perspective view of a component being sandblasted to form a texture thereon.

### DETAILED DESCRIPTION

The following description is merely exemplary in nature and is not intended to limit the present disclosure, application, or uses. It should be understood that throughout the drawings, corresponding reference numerals indicate like or corresponding parts and features.

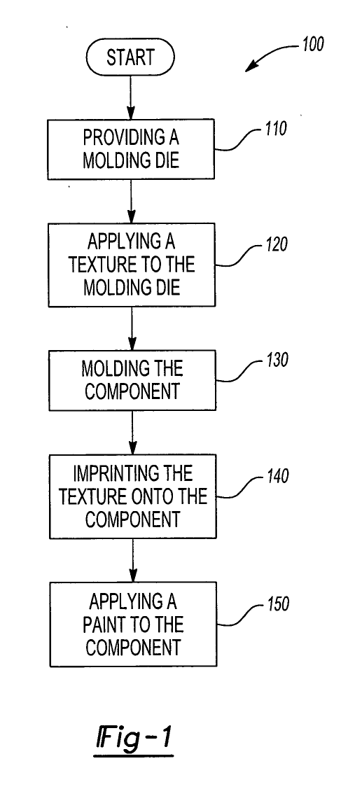

With reference to FIGS. 1-3, one embodiment of a method of adhering paint to a component is illustrated at FIG. 1 and is generally indicated by reference numeral 100. As will be discussed in greater detail below, the method of adhering paint to a component 100 (hereinafter “the method”) may increase a surface tension of the component 10, which may decrease a contact angle between the component 10 and paint 12. Liquid droplets may exhibit contact angles greater than 90 degrees, for example, on surfaces of hydrophobic materials (such as, for example, polypropylene and other polymers). The contact angle between a liquid and a hydrophobic surface decreases as the surface tension is increased. Decreasing the contact angle to below 90 degrees may allow the paint 12 to spread and wet the component 10, allowing the paint 12 to adhere to the component 10 (see FIG. 3), rather than beading up thereon.

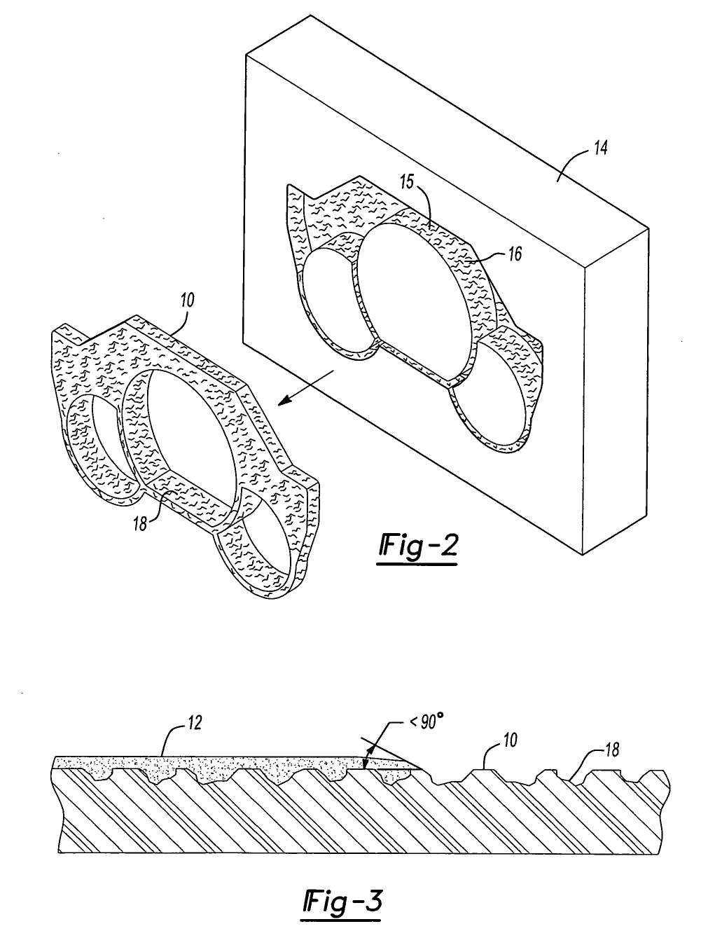

The component 10 may be an instrument cluster frame (FIG. 2), for example, molded to house and display instruments in a vehicle, such as, for example, a speedometer, a tachometer, a fuel gauge, and/or other gauges and instruments that may display information to a driver of the vehicle. The component 10 may be formed from any material, especially polypropylene and other polymeric materials. It should be appreciated that the component 10 could be any molded component formed from any suitable material without departing from the scope of the present disclosure.

With continued reference to FIGS. 1-3, the method 100 will be described in detail. First, block 110 entails providing a molding die 14. More specifically, providing a molding die (or die) 14 may entail forming a cavity within a block of material, the cavity having a plurality of surfaces 15 which may form a negative (or inverse) of the shape of the component 10 (see FIG. 2), such that a liquid polymer (or other material) may solidify within the die 14 to form the component 10, as is known in the art. The die 14 may be machined or otherwise formed from steel, iron, aluminum, or any other suitable material.

Block 120 may entail applying a texture 16 to the surfaces 15 of the die 14. The texture 16 may include a plurality of recesses, e.g., scratches and/or other deformations and imperfections. A grade of the texture 16 should be sufficient to raise a surface tension of the component 10 (described in detail below) to within a required range. In one embodiment, the grade of the texture 16 may be about TH-110 (or WN3015) or equivalent. It should be appreciated that the texture 16 could be applied to the die 14 concurrently with forming the die 14, i.e., blocks 110 and 120 could occur simultaneously.

The texture 16 may be applied to the die 14 by a sandblasting process, in which standard shop air (e.g., about 60 to about 80 psi) may be utilized to cause blasting media to impact surfaces of the die 14 at high speeds. The blasting media size, shape and material can be rated to yield the texture grade of about TH-110. It should be appreciated that applying the texture 16 to the die 14 is not limited to sandblasting processes and may be accomplished by any of several other suitable processes, including filing, sanding, chiseling, acid etching, and/or any other process capable of applying a suitable texture to the die 14.

The next step, block 130, may include forming the component 10 in the die 14 (i.e., molding the component 10). Liquefied material may be inserted into the die 14 and may solidify therein (according to the principles of known molding, casting, and/or forming processes) to produce the shape of the component 10. The component 10 may be formed by injection molding, blow molding, extrusion, or any other molding, forming or casting process known in the art to be suitable for shaping components in the die 14.

Block 140 may entail imprinting the texture 16 of the molding die 14 into the component 10. More specifically, the inverse of the texture 16 may be imprinted onto the component 10 during the steps of block 130, causing the formation of a texture 18 on the component 10 (FIG. 3), i.e., forming the texture 18 onto the component 10 may occur simultaneously with forming the component 10 in the molding die 14. The texture 18 may have a grade of about TH-110 to increase a surface tension of the component 10 to at least about 30 dynes per centimeter or between about 30 dynes per centimeter to about 34 dynes per centimeter.

The next step, block 150, may entail applying the paint 12 to the component 10. The paint 12 may be applied to the component 10 by any suitable means known in the art, such as, for example, spraying, brushing, or submerging the component in the paint 12. The paint 12 may be a water based paint such as, for example, Red Spot® paint, or any other paint suitable for application to polymeric surfaces.

A surface tension within about 30-34 dynes per centimeter may be sufficient to reduce the contact angle between the paint 12 and surfaces of the component 10 to below 90 degrees, for example, thereby inducing the paint 12 to wet the component 10. Significant wetting of the surface of the component 10 causes the paint 12 to adhere thereto (see FIG. 3).

The paint 12 may be applied to the component 10 to substantially fill the plurality of recesses of the texture 18, giving the painted surface of the component 10 a smooth and aesthetically pleasing appearance (FIG. 3).

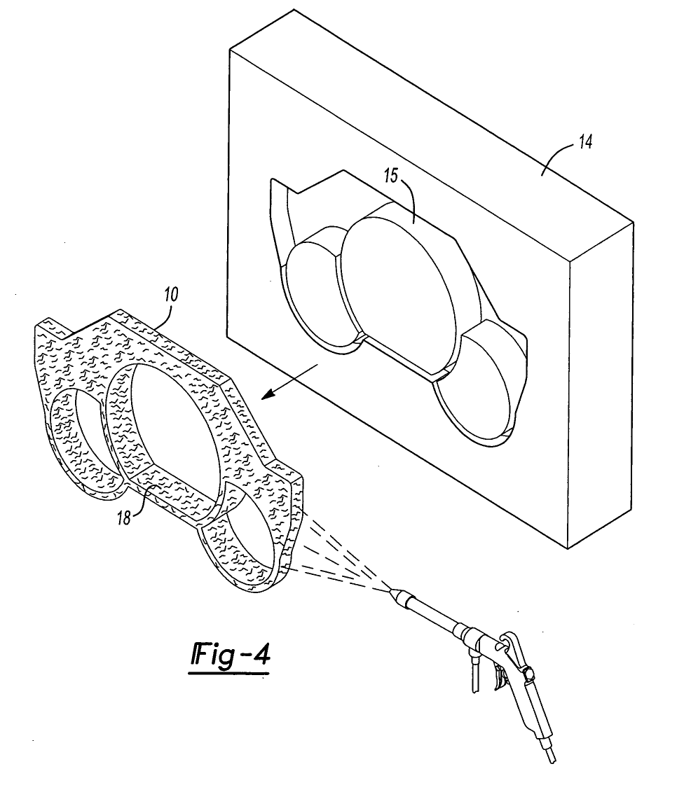

With reference to FIG. 4, the method 100 could include forming the texture 18 onto the component 10 after the molding process 130 particularly for prototype and/or low volume production of the component 10. For example, each component 10 may be sandblasted (as shown in FIG. 4), sanded, or otherwise abraded and/or textured to achieve the requisite surface tension.

Referring now to FIGS. 1-4, there are multiple advantages to the teachings of the present disclosure. The methods of adhering paint (e.g., water based paint) to the component according to the present disclosure solves the long felt, but unresolved need for an efficient method of adhering paint to certain materials, including polypropylene and other polymers.

Imprinting the texture 16 onto the component 10 directly from the die 14 renders each component 10 ready for painting (i.e., each component has the requisite surface tension to facilitate paint adhesion) without an additional step after the molding process. In this manner, components may be mass produced without adding steps in the production process, as only the molding die 14 is treated, thereby only adding one step to the tooling preparation process. The added step to the tooling preparation process may be more readily absorbed through production of multiple components 10, as the additional tooling costs will be spread out thereover.

Imprinting the texture 16 into the component 10 via the molding die 14 as described above with reference to block 140 also improves the reliability and repeatability of the texturing process. The method 100 may reduce variances in the texture 18 of the component 10, when each component 10 is molded from the same molding die 14.

However, as described above, the embodiment of the method 100 wherein the texture 18 is formed onto the component 10 after the component 10 is molded may be well suited for low volume production of the component 10. Additionally or alternatively, forming the texture 18 after molding the component 10 may allow customization of the method 100 for individual components, for example, if the painted portions of the component 10 differ for each production run. One of ordinary skill in the art will appreciate from the present disclosure that a variety of other reasons may render this embodiment (i.e., forming the texture 18 after molding the component 10) more suitable than the former embodiment (i.e., simultaneously forming the texture 18 and molding the component 10) described herein.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method of adhering paint to a molded component comprising:
providing a molding die adapted to mold the molded component;
forming the molded component in the molding die;
forming a texture including a plurality of recesses onto the molded component; and
applying a paint to the molded component and into the plurality of recesses.

2. The method of adhering paint to a molded component according to claim 1, further comprising applying a texture to the molding die.

3. The method of adhering paint to a molded component according to claim 2, wherein the texture of the molding die has a grade of about TH-110.

4. The method of adhering paint to a molded component according to claim 2, wherein applying the texture further comprises sandblasting the molding die to impart the texture to a surface of the molding die.

5. The method of adhering paint to a molded component according to claim 4, wherein sandblasting the molding die further comprises a blasting pressure of about 60 psi to about 80 psi.

6. The method of adhering paint to a molded component according to claim 1, wherein the texture is formed on the molded component after forming the molded component in the molding die.

7. The method of adhering paint to a molded component according to claim 1, wherein forming the texture onto the molded component further comprises increasing the surface tension of the molded component to at least about 30 dynes per centimeter.

8. The method of adhering paint to a molded component according to claim 1, wherein forming the texture onto the molded component further comprises increasing the surface tension of the molded component to between about 30 dynes per centimeter and about 34 dynes per centimeter.

9. The method of adhering paint to a molded component according to claim 1, wherein applying the paint further comprises applying a water based paint.

10. The method of adhering paint to a molded component according to claim 1, wherein applying the paint further comprises applying the paint so as to fill the texture of the molded component with paint.

11. The method of adhering paint to a molded component according to claim 1, wherein the molded component is an instrument cluster frame.

12. The method of adhering paint to a molded component according to claim 11, wherein the molded component is formed from a polymeric material.

13. A method of adhering paint to a polypropylene component comprising:
forming a molding die adapted to shape a polypropylene component;
sandblasting a texture onto a surface of the molding die, the texture including a plurality of recesses;
molding the polypropylene component in the molding die, the texture imprinting onto a surface of the polypropylene component; and
applying a paint to the surface of the polypropylene component,
wherein the texture increases a surface tension of the polypropylene component to facilitate adhesion of the paint to the surface of the polypropylene component.

14. The method of adhering paint to a polypropylene component according to claim 13, wherein imprinting the texture onto the surface of the polypropylene component further comprises increasing the surface tension of the polypropylene component to at least about 30 dynes per centimeter.

15. The method of adhering paint to a polypropylene component according to claim 14, wherein applying the paint further comprises applying the paint so as to fill the plurality of recesses of the polypropylene component with paint.

16. The method of adhering paint to a polypropylene component according to claim 15, wherein the polypropylene component is a molded instrument cluster frame.

17. The method of adhering paint to a polypropylene component according to claim 13, wherein sandblasting a texture onto a surface of the molding die further comprises a blasting pressure of about 60 psi to about 80 psi.

18. The method of adhering paint to a polypropylene component according to claim 13, wherein the texture of the molding die has a grade of about TH-110.

19. The method of adhering paint to a polypropylene component according to claim 13, applying the paint further comprises applying a water based paint.

20. The method of adhering paint to a polypropylene component according to claim 13, wherein imprinting the texture onto the surface of the polypropylene component further comprises increasing the surface tension of the molded component to between about 30 dynes per centimeter and about 34 dynes per centimeter.
